(19) United States
(12) Patent Application Publication
(10) Pub. No.: US 2020/0092080 A1
(43) Pub. Date: Mar. 19, 2020

(54) UNBREAKABLE COMMUNICATION CYPHER WITHOUT A PRELIMINARY SHARING OF RANDOM ELEMENTS

(71) Applicants: Mikhail M. Mestechkin, San Diego, CA (US); Tanya Mestechkina, San Diego, CA (US)

(72) Inventors: Mikhail M. Mestechkin, San Diego, CA (US); Tanya Mestechkina, San Diego, CA (US)

(21) Appl. No.: 16/109,085

(22) Filed: Sep. 17, 2018

(51) Int. Cl. H04L 9/06

(52) U.S. Cl. CPC H04L 9/0631

(57) ABSTRACT

Proposed secure communication methods are based on a specific numbering of every n-block (the block number is a cyphered text). Because of a random number included in block plain text, the block number itself becomes random. Since any random number is used only once, the method satisfies the Shannon criterion for the unbreakable code, but does not require a delivery of the random elements to recipient in advance. Recipient should know only its position in a block. Reciprocal math procedures, including a special hash-function of binomial coefficients, allow extracting the plain text from the block number. The system distinguishes immediately a false cypher message. We programmed three restricted algorithms: “dictionary”, “anagram”, and “division” (maximal block carries ≈95 exbibyte as compared to 64 kibibyte in the main unite of AES). The necessary equipment is an average quality commercial computer for each communicating party.

### BACKGROUND OF THE INVENTION

This Nonprovisional (Utility) patent application offers a useful improvement to the process of secure communication. Currently, the major methods of modern cypher are the one-time pad (OTP) method, the advanced encryption standard (AES) method, and the Ron Rivest, Adi Shamir, and Leonard Adleman (RSA) method. Each method has benefits and drawbacks in terms of complexity, security and utility.

The widespread OTP method uses plain text paired with a pre-shared random key text. Gilbert S. Vernam received U.S. Pat. No. 1,310,719 for an early version of this method at the beginning of the 20th century. Secret agents employed the method to send clandestine telegraph messages by combining each plain character on a ticker tape with a random character that was typed on the corresponding row of that tape. However, the agents had to deliver a duplicate of this key tape with only the random characters to the recipient in advance. Claude Shannon, the father of information theory, proved a theorem that the method of combining a message with a stream of purely random numbers used only once cannot be cracked. Thus, even a simple schoolyard cypher can deliver perfect secrecy. However, every version of the OTP method requires the one-time use of a pre-shared random key text for each of the characters in the message.

The AES method established by the U.S. National Institute of Standards and Technology (NIST) in 2001 uses plain text transformed by a sequence of substitution-permutation procedures. The sender applies the procedures [usually to a set of “bytes” (0, 1)] to encrypt the text and the receiver applies the reciprocal procedures to decode the message. However, these practically used procedures have recently been cracked.

The RSA method based on Leonhard Euler's generalization of the “little Fermat theorem” uses an algorithm that allows for separate public and private keys. Instead of transferring a certain number, this method transfers the remainder of the division of the number raised to a very high power by the product of two large secret primes keeping the product itself public. The Massachusetts Institute of Technology (MIT) received U.S. Pat. No. 4,405,829 for the RSA method in 1983. It was called the RSA method for the last names of its authors. In a more general sense, it can be called the “math” method as based on mathematical “tricks”. The practical use of the RSA method requires strong calculational tools, great mathematical skill, and the development of effective mathematical methods for finding large primes. It also carries the possibility that a recipient who knows the two large secret primes (not only their product, which is available to the public) could use Fermat's theorem to deduce the initial number.

### BRIEF SUMMARY OF THE INVENTION

The grounding principle behind our cypher method differs from all three of the methods above. We propose to substitute each n-block of plain text for a unique number (“block number”), which may sometimes consist of two integers. An n-block is a sequence of characters of a certain length (i.e., 4-blocks include abcd, able, eaut, etc.) We endow the number of each n-block by specific properties, which allow for the restoration of the block plain text by mathematical manipulations of this number. In some sense, the block number contains all of the information that appears in the block itself. Therefore, the block number serves as a block cypher text. The sizes of the plane and cypher texts have no direct connection: the former can be larger as well as smaller than the latter in contrast to the standard cryptography. For instant, the popular monography B. Schneier's “Applied cryptography” starts from the assertion that “the cypher text is sometimes the same size as the plain text, sometimes larger”.

We can number letters because their order in the alphabet is fixed. For instance, in English, the sequence is ₁, A₂, B₃, C₄, . . . , X₂₅, Y₂₆, Z₂₇ (the number 1 is assigned to the interval). Likewise, we can number words because they are listed in a dictionary alphabetically (lexicographically). Similarly, we can number all n-character blocks (vectors of characters' numbers k₁, k₂, . . . , kₙ in an alphabet of length m). The total number of n-blocks is rather large: mⁿ. For example, there are 27¹⁵=2,954,312,706,550,833,698,643 English 15-letter blocks. This makes the creation of a “block dictionary” impossible.

One way to deal with this problem is to calculate the block number from the available numbers k₁, k₂, . . . , kₙ as described in the section entitled “Detailed Description of the Invention” below. First, we transform the block of plain text (which is merely a “chaotic” set of letters) into increasing sequences of n numbers. Such sequences can, in turn, be numbered. We deduced the formula for the number on our own because we did not find it in the literature. Knowing the n-block number, we can use the set of reciprocal formulae, also derived by us, to find k₁, k₂, . . . , kₙ. The procedures of finding the n-block number and k₁, k₂, . . . , kₙ are the basis for our method of encoding and decoding. We use two algorithms to transform the block of plain text into a lexicographically ordered sequence. We refer to these algorithms as the dictionary and anagram methods of cryptographic communication. In the dictionary method, a set of auxiliary numbers s₁=k₁, s₂=k₁+k₂, s₃=s₂+k₃, . . . , sₙ=sₙ₋₁+kₙ is attached to the initial sequence k₁, k₂, . . . , kₙ. The numbers sⱼ are ordered lexicographically: s₁<s₂< . . . <sₙ. Having obtained the sequence s₁, s₂, . . . , sₙ number, we can treat this number as the number of the initial k-sequence because it determines kⱼ as well: k₁=s₁, kⱼ=sⱼ−sⱼ₋₁, j=2, 3, . . . , n.

The anagrams were used for cyphering since the Middle Ages. In those days, scientists wrote their discoveries in the form of anagrams to prove their priority. An anagram is simply a set of, say, l different letters (k₁, k₂, . . . , kₗ) that is usually (but not always) written in alphabetical order. Each letter may be repeated in the anagram several times: n₁, n₂, . . . , nₗ, n₁+n₂+ . . . +nₗ=n, where n is the total number of characters in the anagram (block). Medieval scientists deciphered the anagram after their discoveries had been verified, keeping the same number of each letter in the decoded text the same as in the anagram. Thus, the anagram played the part of the modern provisional patent. The most famous historical anagram is connected to Galileo Galilei's discovery of the planet Saturn's rings. He announced his observation in the anagram Smaismrmielmepoetaleumibuvnenugttaviras. The well-known astronomer J. Kepler assumed that Galileo had discovered two of Mars' satellites. After omitting two random letters, Kepler combined the rest of the letters into the Italian phrase “Salve umbestinium geminatum martia proles,” which means, “Hallow to you, Geminis, Mars' origination.” Galilei decoded the anagram after he verified his discovery. After omitting two random letters, he rearranged the rest of the letters to write, “Altissimum planetam tergeminum observavi,” which means, “I observed the highest planet as double.”

Kepler's error reveals that knowledge of the letters in the anagram is not enough to restore the plain text because the reader needs additional information to organize the letters correctly. In the section entitled “Detailed Description of the Invention,” we will demonstrate that knowledge of two unique numbers is sufficient to allow the reader to restore both the letter composition and the initial text of any anagram (n-block). These two numbers will become our cypher message.

By replacing of the block of plain text with the block number, we can include in the text a random character (random number) that the recipient need not know in advance. The recipient need only know the position of the random number in the block. The position of the random number can serve as a private key because the block number depends on the positions of all of the letters in the text. Since the block number contains a random element, the block number becomes random itself. Thus, similarly to the OTP method, the same n-block sent many times will have a different block number each time.

The sender and recipient can agree in advance not only on a position of a random number but also on a rule for the preliminary alteration of the plain text that depends on this random number, which is present in the text. For instance, they can agree to replace the numbers of all of the letters in a block by the sum (mod 27) of each and the random number. Then the block number to-be-sent is calculated for these modified letter numbers. The recipient restores the letters applying modular subtraction to the decoded letter numbers. They even can agree on different similar rules for each weekday, etc. It is clear that such additional private keys enhance the security of communication significantly.

Our methods contain a specific self-defense mechanism. The total number

$$( \begin{matrix}mn \\ n\end{matrix} )$$

of possible sequences (s₁, s₂, . . . , sₙ) is significantly greater than the total number (mⁿ) of n-blocks in the m-alphabet. This guarantees that it will immediately be obvious when a hacker uses a random number to crack the cypher. Indeed,

$$( \begin{matrix}mn \\ n\end{matrix} ) / {m}^{n} = ( \begin{matrix}405 \\ 15\end{matrix} ) ) / {27}^{15} = ( \frac{760961339479277429958715320}{2954312706550833698643} ) = 257576.4$$

In other words, the system will not recognize at once the false number sent for decoding only in one out of a quarter-a-million cases.

### DETAILED DESCRIPTION OF THE INVENTION

Dictionary Method of Cryptographic Communication

We can extract the n-block content from its number by using a formula for the number of ordered sequences s₁, s₂, . . . , sₙ. The largest possible of these quantities is sₙ=nm (it appears when the block consists of the last letter of the alphabet repeated n times). The total number of values that each of s-quantities can obtain is mn. Therefore, the total number of all increasing n-long sequences of sⱼ is the binomial coefficient

$$( \begin{matrix}mn \\ n\end{matrix} ) = \frac{( mn ) !}{n ! ( mn - n ) !} .$$

We deduced the number of the sequence s₁<s₂< . . . <sₙ by induction because (as already mentioned) we did not find it in the literature. The formula is

$${N}_{{k}_{1} {k}_{2} … {k}_{n}} = ( \begin{matrix}mn \\ n\end{matrix} ) - {\sum }_{j = 1}^{n} ( \begin{matrix}mn - {s}_{j} \\ n - j + 1\end{matrix} ) , {k}_{1} = {s}_{1} , {k}_{p} = {s}_{p} - {s}_{p - 1} , p = 2 , 3 , … , n . \qquad ( 1 )$$

In particular, the empty n-block, corresponding to k₁=k₂= . . . =kₙ=1 and sⱼ=j has the number 1 because the sum (1) is equal to

$$( \begin{matrix}mn \\ mn - n\end{matrix} ) - 1.$$

If the last letter of a block has the number k, and the rest of block is empty, then k is simultaneously the number of the block itself. If the last number in a block is Ŗ+1, where Ŗ is a random number, then the block number is Nₖ_{₁}ₖ_{₂} _{. . . k}_{_{n−1}}+Ŗ. This corresponds to the rule for the use of random numbers in the OTP method.

Upon receipt of the number Nₖ_{₁}ₖ_{₂} _{. . . k}_{ₙ}, the recipient can convert the block number back into plain text using the hash function L(n, N) to find a set of n auxiliary numbers Nⱼ, which allow to restore the sets of parameters sⱼ and kⱼ.

$$\begin{matrix} {N}_{1} = ( \begin{matrix}mn \\ n\end{matrix} ) - {N}_{{k}_{1} {k}_{2} {…k}_{l} ,} {s}_{1} = mn - L ( n , {N}_{1} ) , {k}_{1} = {s}_{1} , & ( 2 ) \\ {N}_{j + 1} = {N}_{j} - ( \begin{matrix}mn - {s}_{j} \\ n - j + 1\end{matrix} ) , {s}_{j + 1} = mn - L ( n - j , {N}_{j + 1} ) , {k}_{j + 1} = {s}_{j + 1} - {s}_{j} , j = 1 , 2 , … , n . & ( 3 )\end{matrix}$$

The integer function L(n, N) is defined by the inequality:

$$if ( \begin{matrix}L \\ n\end{matrix} ) < N < ( \begin{matrix}L + 1 \\ n\end{matrix} ) ,$$

then L(n, N)=L. Thus, in principle, the whole table of binomial coefficients up to N with the lower argument n is needed to obtain L. We found the approximate value of L is L′=[(n!N)^{1/n}+n/2] ([ ] denote the integer part). The calculation of L′ facilitates search for L. Starting with L′, we increase or decrease L one by one until the inequality is satisfied.

Here is a demonstration of all of the manipulations. We assume that the recipient knows the order of the letters in the English alphabet (A before B before C, etc.) and the block length (n=8). Let us pretend that the block to be sent is “IT IS IT”=10,21,1,10,20,1,10,21. It is necessary to calculate N_{IT IS IT}=N_{10,21,1,10,20,1,10,21}. First, find s₁=10, s₂=31 s₃=32, s₄=42, s₅=62, s₆=63, s₇=73, s₈=94. Then, according to Eq. (1),

$${N}_{IT IS IT} = ( \begin{matrix}216 \\ 8\end{matrix} ) - ( \begin{matrix}206 \\ 8\end{matrix} ) - ( \begin{matrix}185 \\ 7\end{matrix} ) - ( \begin{matrix}184 \\ 6\end{matrix} ) - ( \begin{matrix}174 \\ 5\end{matrix} ) - ( \begin{matrix}154 \\ 4\end{matrix} ) - ( \begin{matrix}153 \\ 3\end{matrix} ) - ( \begin{matrix}143 \\ 2\end{matrix} ) - ( \begin{matrix}122 \\ 1\end{matrix} ) = 103073959989495 - 70090194034675 - 1311854301420 - 49637730324 - 1254260034 - 22533126 - 585276 - 10153 - 122 = 31 \; 620 \; 996 \; 534 \; 365.$$

Naturally, this number could be altered by including a random character. For example, if the users know the “magic number 3”, then the sender can include a random number (say, 7) in the third place in the text of his message. The recipient need only know the position 3, not the random number 7. Hence, instead of 31620996534365, the sender now forwards 2146696394958536, which results in the message 10,21,7,1,10,20,1,10,21. If he chooses the random number 19, the message is 2147674729711155, etc. The sender could also preliminarily alter the message in the manner described in the prior section to enhance the influence of the private key.

Reverse transformations (2,3) will return the message to the plain text. N₁=103073959989495−31620996534365=71452963455130. Before the recipient can calculate s₁=216−L(8, N₁), he must find L′=[(8!71452963455130)^{1/8}+4]=[206.975 . . . ]=206 and verify that

$$( \begin{matrix}206 \\ 8\end{matrix} ) = 7009019403 < 71452963455130 < ( \begin{matrix}207 \\ 8\end{matrix} ) = 72907890277275.$$

Therefore, s₁=k₁=216−206=10. Further,

$${N}_{2} = 71452963455130 - ( \begin{matrix}207 \\ 8\end{matrix} ) = 1362769420455 ,$$

s₂=216−L(7, N₂)=216−185=31, k₂=31−10=21, as L′=[(7!1362769420455)^{1/7}+3.5]=[186.482 . . . ]=186,

$$( \begin{matrix}186 \\ 7\end{matrix} ) = 1363155866280 > 1362769420455 > ( \begin{matrix}185 \\ 7\end{matrix} ) = 1311854301420.$$

N₃=1362769420455−(185|7)=50915119035, s₃=216−L(6, N₃)=216−184=32, k₃=32−31=1, as L′=[(6!50915119035)^{1/6}+3]=[185.262 . . . ]=185 since

$$( \begin{matrix}185 \\ 6\end{matrix} ) = 51301564860 > 50915119035 > ( \begin{matrix}184 \\ 6\end{matrix} ) = 49637730324.$$

N₄=50915119035−(184|6)=1277388711, s₄=216−L(5, N₄)=216−174=42, k₃=42−32=10, as L′=[(5!1277388711)^{1/5}+2.5]=[175.124 . . . ]=175 and

$$( \begin{matrix}175 \\ 5\end{matrix} ) = 1291150035 > 1277388711 > ( \begin{matrix}174 \\ 5\end{matrix} ) = 1254260034.$$

N₅=1277388711−(174|5)=23128677, s₅=216−L(4, N₅)=216−154=62, k₅=62−42=20, as L′=[(4!23128677)^{1/4}+2]=[155.494 . . . ]=155 and

$$( \begin{matrix}155 \\ 4\end{matrix} ) = 23130030 > 23128677 > ( \begin{matrix}154 \\ 4\end{matrix} ) = 22533126.$$

N₆=23128677−(154|4)=595551, s₆=216−L(3, N₆)=216−153=63, k₆=63−62=1, as

$${L}^{′} [ {( 3 ! 595551 )}^{1 / 3} + 1.5 ] = [ 154.4 ] = 155 and \\ ( \begin{matrix}154 \\ 3\end{matrix} ) = 596904 > 595551 > ( \begin{matrix}153 \\ 3\end{matrix} ) = 585276.$$

N₇=595551−(153β)=10275, s₆=216−L(2, N₇)=216−143=73, k₇=73−63=10, as L′=[(2!10275)^{1/2}+1]=[144.4]=144 and

$$( \begin{matrix}144 \\ 2\end{matrix} ) = 10296 > 10275 > ( \begin{matrix}143 \\ 2\end{matrix} ) = 10153.$$

N₈=10275−(143|2)=122, s₈=216−L(1, N₈)=216−122=94, k₈=94−73=21, as

$$( \begin{matrix}123 \\ 1\end{matrix} ) = 123 > 122 \geq ( \begin{matrix}122 \\ 1\end{matrix} ) = 122.$$

N₉=122−(122|1)=Nₙ₊₁=0 verifies the results of the calculation of k₈, k₇, . . . , k₁ and the restored plain text “IT IS IT.”

Note Introducing natural numbering of letters, in fact, we use “27-nary” system. It means that 9-block carries 27⁹/2⁴⁰=6.93544 . . . tebibyte of information as compared to 64 kilobyte in the main unit of AES system. We have created a computer program, which uses standard double-digit accuracy that can perform calculations for 9-blocks at the encoding and decoding terminals. It is included as an attachment.

### Anagram Method of Cryptographic Communication

We can also extract the n-block content from its number by substituting two numbers for the plain text of any n-block. The anagram method requires less computation than the dictionary method. It also allows us to send numbers to two different addressees and require their unification in order to decipher the message.

Before we encode each n-block, we transform it into an anagram of n characters of the m-alphabet by placing all of the l different letters in the block in alphabetical order and counting the numbers n₁, n₂ . . . nᵢ, which indicate how many times each letter appears in the block. The anagram can be written symbolically as k₁ⁿ^{₁}k₂ⁿ^{₂} . . . kₗⁿ^{ₗ}, k₁<k₂< . . . <kₗ. The sum n₁+n₂+ . . . +nₗ is equal to the block size n. Once the anagram letters and the auxiliary quantities sⱼ, defined as sⱼ=n₁+n₂+ . . . +nⱼ, have been ordered, we can derive the formulae for the anagram number by induction:

$$G = ( \begin{matrix}n + {k}_{l} - 1 \\ n\end{matrix} ) + {\sum }_{j = 1}^{l - 1} [ ( \begin{matrix}{s}_{j} + {k}_{j + 1} - 1 \\ {s}_{j}\end{matrix} ) - ( \begin{matrix}{s}_{j} + {k}_{j + 1} - 1 \\ {s}_{j}\end{matrix} ) ] , \\ {s}_{j} = {\sum }_{p = 1}^{j} {n}_{p} , {s}_{l} = n \qquad ( 4 )$$

Let us once again pretend that the message is “IT IS IT”=10,21,1,10,20,1,10,21. Here, l=4, k₁=1, k₂=10, k₃=20, k₄=21; n₁=2, n₂=3, n₃=1, n₄=2; s₁=2, s₂=5, s₃=6, s₄=n=8, and

$$G = ( \begin{matrix}28 \\ 8\end{matrix} ) + ( \begin{matrix}2 \\ 2\end{matrix} ) - ( \begin{matrix}11 \\ 2\end{matrix} ) + ( \begin{matrix}14 \\ 5\end{matrix} ) - ( \begin{matrix}24 \\ 5\end{matrix} ) + ( \begin{matrix}25 \\ 6\end{matrix} ) - ( \begin{matrix}26 \\ 6\end{matrix} ) = 3108105 + 1 - 55 + 2002 - 42504 + 177100 - 230230 = 3 \; 014 \; 419.$$

The order of magnitude of the number is two times smaller using the anagram method than using the dictionary method.

It is essential that the permutation, which shows how all of the letters in the anagram are ordered in the block, can itself be numbered. These two numbers, denoted by G and K (which could be preliminarily altered as discussed above to serve as a private key) form the message produced at the encoding terminal. The second number is greater than the first number if the length of the alphabet does not exceed (ⁿ⁺¹₂)

The calculation of K is based on the formula for the permutation that shows the position of the letters in the block.

$$( \begin{matrix}1 , 2 , … , l & l + 1 , … , l + {m}_{2} & … & n - {m}_{max} + 1 , n - {m}_{max} + 2 , … , n \\ {p}_{1}^{( 1 )} , {p}_{1}^{( 2 )} , … , {p}_{1}^{( l )} & {p}_{2}^{( i )} , {p}_{2}^{( j )} , … , {p}_{2}^{( k )} & … & {p}_{{n}_{max}}^{( u )} , {p}_{{n}_{max}}^{( v )} , … , {p}_{{n}_{max}}^{( w )}\end{matrix} ) \qquad ( 5 )$$

The first row contains the numbers 1, 2, . . . , l of all of the different letters in the block in alphabetical order. The second row reveals the position in the block where each of the letters appears for the first, second, third, etc. time. The right-hand columns correspond to the letters that appear the most times. The number m_{q} (the last superscript of p_{q}^{(j)}) indicates the number of letters that appear q times. The second row consists of the same numbers as the first row, only in a different order, m₁+m₂+ . . . +mₘₐₓ=n, m₁=l, and the sum of all of the numbers in the second row is 1+2+ . . . +n=n(n+1)/2. Thus, p_{q}^{(j)} is the number of the position at which the j^{th} letter appears in the block for the q^{th} time.

It is easier to see the structure of the permutation (5) if we place the letters (instead of their numbers) in the first row. The permutation for “IT IS IT” looks like this:

$$( \begin{matrix} & I & S & T & & I & T & I \\ 3 & 1 & 5 & 2 & 6 & 4 & 8 & 7\end{matrix} ) .$$

Such a notation, which has repetitions in the first row, is more aptly named a collocation, rather than a permutation.

Changing the order of columns, we can redistribute the letters in the first row in the same order as the anagram. Thus, we can use the formula (4) to number the permutation after the substitutions kⱼ→j, nⱼ→pⱼ, n→n(n+1)/2. We can obtain the reciprocal formulae from the equations (2, 3). This gives

$$K = ( \begin{matrix}( {n}^{2} + 3 n - 2 ) / 2 \\ n - 1\end{matrix} ) - {\sum }_{j = 1}^{n - 1} ( \begin{matrix}{s}_{n - j} + n - j - 1 \\ n - j\end{matrix} ) , {s}_{j} {\sum }_{i = 1}^{j} {p}_{i} . \qquad ( 6 )$$

where the subscript at pᵢ is the number of the p_{q}^{(j)} place in the second row of the permutation (5). To calculate the number K, we take the numbers from the second row of the collocation, find s₁=3, s₂=4, s₃=9, s₄=11, s₅=17, s₆=21, s₇=29, s₈=36, and obtain

$$K = ( \begin{matrix}43 \\ 7\end{matrix} ) - ( \begin{matrix}35 \\ 7\end{matrix} ) - ( \begin{matrix}26 \\ 6\end{matrix} ) - ( \begin{matrix}21 \\ 5\end{matrix} ) - ( \begin{matrix}14 \\ 4\end{matrix} ) - ( \begin{matrix}11 \\ 3\end{matrix} ) - ( \begin{matrix}5 \\ 2\end{matrix} ) - ( \begin{matrix}3 \\ 1\end{matrix} ) = 32224114 - 6724520 - 230230 - 20349 - 1001 - 165 - 10 - 3 = 25247836.$$

Using the two numbers G and K, the recipient can decipher the text by applying the reciprocal mathematical procedures. To return from the anagram number to the letter numbers and their multiplicities, the recipient begins with N⁽¹⁾=G, s⁽¹⁾=n and uses the sequence of equalities, in which the superscripts numbering the steps of the calculation are connected to the subscripts of the letters and multiplicities in the anagram as follows: k^{(l-j+1)}=kⱼ, s^{(l-j+1)}=sⱼ. These equalities for j=1, 2, . . . l−1 are

$$\begin{matrix} {k}^{( j )} = L ( {s}^{( j )} , {N}^{( j )} ) - {s}^{( j )} + 2 , {M}^{( j )} = ( \begin{matrix}{k}^{( j )} + {s}^{( j )} - 1 \\ {s}^{( j )}\end{matrix} ) - {N}^{( j )} ; & ( 7 ) \\ {s}^{( j + 1 )} = L ( {k}^{( j )} - 1 , {M}^{( j )} ) - {k}^{( j )} + 2 , {N}^{( j + 1 )} = ( \begin{matrix}{k}^{( j )} + {s}^{( j + 1 )} - 1 \\ {k}^{( j )} - 1\end{matrix} ) - {M}^{( j )} . & ( 8 )\end{matrix}$$

In the peculiar situation: L(s^{(j)}, N^{(j)})=N^{(j)} (not <), a modified equation k^{(j)}=L(s^{(j)}, N^{(j)})−s^{(j)}+1 should be used. The appearance of N^{(l-1)}=0 finalizes the calculations and determines the number of different letters l in the anagram, which the recipient did not previously know.

To establish the order of the letters in the block, he restores permutation (4) from the number K, applying the following equations n−1 times. The last n^{th} step is the simplest: p₁=s₁ (Nₙ=0, s₁ is determined at the preceding step).

$$\begin{matrix}{N}_{1} = ( \begin{matrix}( {n}^{2} + 3 n - 2 / 2 \\ n - 1\end{matrix} ) - {N}_{P} , {s}_{n - 1} \\ = L ( n - 1 , {N}_{1} ) - n + 2 , {p}_{n} \\ = ( n + 1 \vert 2 ) - {s}_{n - 1}\end{matrix} \\ \begin{matrix}{N}_{j + 1} = {N}_{j} - ( \begin{matrix}{s}_{n - j} + n - j - 1 \\ n - j\end{matrix} ) , {s}_{n - j - 1} \\ = L ( n - j - 1 , {N}_{j + 1} ) - n + j + 2 , {p}_{n - j} \\ = {s}_{n - j} - {s}_{n - j - 1} .\end{matrix} \qquad ( 9 )$$

The same hash function L(n, N) that was introduced in the dictionary method appears in formulae (7-9).

Knowing the two numbers G=3014419 and K=25247836 (the block size n is a fixed parameter of communication), and applying the formulas (7,8), recipient obtains k⁽¹⁾=L(8,3014419)−6=27−6=21 as L′=[(8!⋅3014419)^{1/8}+4]=[28.3 . . . ]=28 and

$$2220075 = ( \begin{matrix}27 \\ 8\end{matrix} ) < 3014419 < ( \begin{matrix}28 \\ 8\end{matrix} ) = 3108105 , \\ {M}^{( 1 )} = ( \begin{matrix}28 \\ 8\end{matrix} ) - 3014419 = 93686 ,$$

s⁽²⁾=L(20,93686)−19=25−19=6 as L′=[(20!⋅93686)^{1/20}+10]=[24.7 . . . ]=24 and

$$( \begin{matrix}25 \\ 20\end{matrix} ) = 53130 < 93686 < ( \begin{matrix}26 \\ 20\end{matrix} ) = 230230 , \\ {N}^{( 2 )} = ( \begin{matrix}26 \\ 20\end{matrix} ) - 93686 = 136544.$$

These calculations are similar to those in the dictionary method. Therefore, we omit the details below. k⁽²⁾=L(6,136544)−4=24−4=20 as

$$( \begin{matrix}24 \\ 6\end{matrix} ) = 134596 < 136544 < ( \begin{matrix}25 \\ 6\end{matrix} ) = 177100 , \\ {M}^{( 2 )} = ( \begin{matrix}25 \\ 6\end{matrix} ) - 136544 = 40556 ,$$

s⁽³⁾=L(19,40556)−18=23−18=5 as

$$( \begin{matrix}23 \\ 19\end{matrix} ) = 8855 < 40556 < ( \begin{matrix}24 \\ 19\end{matrix} ) = 42504 , \\ {N}^{( 3 )} = ( \begin{matrix}24 \\ 19\end{matrix} ) - 40556 = 1948 ;$$

k⁽³⁾=L(5,1948)−3=13−3=10 as

$$( \begin{matrix}13 \\ 5\end{matrix} ) = 1287 < 1948 < ( \begin{matrix}14 \\ 5\end{matrix} ) = 2002 , \\ {M}^{( 3 )} = ( \begin{matrix}14 \\ 5\end{matrix} ) - 1948 = 54 , \\ {s}^{( 4 )} = L ( 9 , 54 ) - 8 = 14 - 12 = 2 as \\ ( \begin{matrix}10 \\ 9\end{matrix} ) = 14 < 54 < ( \begin{matrix}11 \\ 9\end{matrix} ) = 55 , \\ {N}^{( 3 )} = ( \begin{matrix}11 \\ 9\end{matrix} ) - 54 = 1 ,$$

according to the proviso k⁽⁴⁾=1. Finally, n₁=s₁=s⁽⁴⁾=2, n₂=s⁽³⁾−s⁽⁴⁾=5−2=3, n₃=s⁽²⁾−s⁽³⁾=6−5=1, n₄=s⁽¹⁾−s⁽²⁾=8−6=2. Thus, he has restored the anagram: ˜²I³T²S, and the first row of the collocation I S T I T I.

Using formula (9), he then writes the second row starting from the right:

$${N}_{1} = ( \begin{matrix}43 \\ 7\end{matrix} ) - 25247836 = 6976278 ,$$

s₇=L(7,6976278)−6=35−6=29 as

$$( \begin{matrix}35 \\ 7\end{matrix} ) = 6724520 < 6976278 < 8347680 = ( \begin{matrix}36 \\ 7\end{matrix} ) ,$$

p₈=36−9=7;

$${N}_{2} = 6976278 - ( \begin{matrix}35 \\ 7\end{matrix} ) = 251758 ,$$

s₆=L(6, 251793)−5=26−5=21 as

$$( \begin{matrix}26 \\ 6\end{matrix} ) = 230230 < 251758 < 296010 = ( \begin{matrix}27 \\ 6\end{matrix} ) ,$$

p₇=29−21=8;

$${N}_{3} = 251758 - ( \begin{matrix}26 \\ 6\end{matrix} ) = 21528 ,$$

s₅=L(5, 21528)−4=21−4=17 as

$$( \begin{matrix}21 \\ 5\end{matrix} ) = 20349 < 21528 < 26334 = ( \begin{matrix}22 \\ 5\end{matrix} ) ,$$

p₆=21−17=4;

$${N}_{4} = 21528 - ( \begin{matrix}21 \\ 5\end{matrix} ) = 1179 ,$$

s₄=L(4, 1179)−3=14−3=11 as

$$( \begin{matrix}14 \\ 4\end{matrix} ) = 1001 < 1179 < 1635 = ( \begin{matrix}15 \\ 4\end{matrix} ) ,$$

p₅=17−11=6;

$${N}_{5} = 1179 - ( \begin{matrix}14 \\ 4\end{matrix} ) = 178 ,$$

s₃=L(3, 178)−2=11−2=9 as

$$( \begin{matrix}11 \\ 3\end{matrix} ) = 165 < 178 < 220 = ( \begin{matrix}12 \\ 3\end{matrix} ) ,$$

p₄=11−9=2;

$${N}_{6} = 178 - ( \begin{matrix}11 \\ 3\end{matrix} ) = 13 ,$$

s₂=L(2,13)−1=5−1=4 as

$$( \begin{matrix}5 \\ 2\end{matrix} ) = 10 < 13 < 15 = ( \begin{matrix}6 \\ 2\end{matrix} ) ,$$

p₃=9−4=5;

$${N}_{7} = 13 - ( \begin{matrix}5 \\ 2\end{matrix} ) = 3 ,$$

s₁=L(1, 3)=3 as

$$( \begin{matrix}3 \\ 1\end{matrix} ) = 3 \leq 3 < 4 = ( \begin{matrix}4 \\ 1\end{matrix} ) ,$$

p₂==4−3=1;

$${N}_{8} = 3 - ( \begin{matrix}3 \\ 1\end{matrix} ) = 0 ,$$

p₁=s₁=3. The second row of collocation is finished, 3,1,5,2,6,4,8,7, and the plain text is restored: “IT IS IT”.

We have created a computer program that can perform such calculations for n=14, m=27 (≈95 exbibyte) at the encoding and decoding terminals and included it as an attachment. As far as we know, formulae for G (4) and K (6) and naturally reciprocal ones (7-9) have never been published by anybody and appear here for the first time.

Division with a Remainder and Taking a Square Root as Cyphering Methods

This simplest technique extends the methods discussed above to users who are unfamiliar with such things as binomial coefficients, but wish to protect their communication from hackers and other unlawful availability.

Let us introduce a set of simple polynomial functions Eₙ(k₁, k₂, . . . , kₙ) with n variables: E₁(k₁)=k₁, E₂(k₁, k₂)=k₁k₂+1, E₃(k₁, k₂, k₃)=k₁k₂k₃+k₁+k₃, E₄(k₁, k₂, k₃, k₄)=k₁k₂k₃k₄+k₁k₂+k₁k₄+k₃k₄+1. These are connected by the recurrent relation Eₙ=kₙEₙ₋₁+Eₙ₋₂, which allow constructing Eₙ of any order. For the divisor and dividend, we use a convenient special notation:

d=Eₙ₋₁(k₁, . . . ,kₙ₋₁), D=Eₙ(k₁, . . . ,kₙ). (10)

To transmit an n-block, it is easier to calculate and send d and D, rather than the letter n numbers k₁, k₂, . . . , kₙ. Having obtained d and D, the recipient can use the Euclidian algorithm to find the greatest common divisor of d and D. All of the intermediate quotients will be kₙ, kₙ₋₁ . . . k₂, k₁! That is precisely why we named this procedure the division method: the Euclidian algorithm consists of subsequent divisions with a remainder.

As before, let us pretend that the message is “IT IS IT”=10,21,1,10,20,1,10,21. We calculate d=E₇(10,21,1,10,20,1,10)=559261 and D=E₈(10,21,1,10,20,1,10,21)=11795543. The recipient carries out the Euclidian algorithm, 11795543/559261=21|51062, 559261/51062=10|48641, 51062/48641=1|2421, 48641/2421=20|221, 2421/221=10|211, 221/211=1|10, 211/10=21|1, 10/1=10|0, and reads our message from right to left. He does not even need to know n!

It is easy to demonstrate on this simple example how a private key protects the information. Let us assume that the user has memorized the magic number 3. He then has a virtually infinite variety of options to choose private keys to protect his message. For instance, he can include a random number, say, 71 in the third position. The recipient does not need to know the number 71 in advance; he needs only to know the position of the random number and manner of its use. For example, if the parties agree to subtract the second digit of the third number from the rest of the numbers to obtain the correct letter numbers, then 4379281363 and 198273763 will replace the above d and D. The divisions (4379281363/198273763=22|17258577, 198273763/17258577=11|8429416, 17258577/8429416=2|399745, 8429416/399745=21|34771, 399745/34771=11|17264, 34771/17264=2|243, 17264/243=71|11, 243/11=22|1, 11/1=11|0) and subtractions (22−1=21, 11−1=10, 2−1=1, 21−1=20, 11−1=10, 2−1=1, 22−1=21, 11−1=10) lead to “IT IS IT” (the vertical line separates a quotient from a remainder). Next time, the parties could agree to use 11 as the random number. Then two different numbers, d=31939666 and D=705452814, would convey the same information, as the reader can verify.

The same polynomials D, d, and similar ones built of part of their arguments may be used to encoding “IT IS IT” with a square root. Here the procedure is somewhat more peculiar. First, we calculate x=d²+D² to find, which period the chain fraction presenting the square root would have. Even x excludes even period, and vice versa. It happens since the number, which we send as our message A=J²+L must be Integer, and J and K, too. The latter are built from polynomials c=Eₙ₋₂(k₂, . . . kₙ₋₁) C=Eₙ₋₁(k₂, . . . kₙ), B=Eₙ₋₂(k₁, . . . kₙ₋₂), b=Eₙ₋₃(k₂, . . . , kₙ₋₂) similar to d and D in two steps. We calculate for the even period x=d(D+B), y=c(C+b), z²=xy+1, and u=1+[y²/2z] (where brackets denote the integer part) and then we can find L=2zu−y², and J=xu−yz/2. For the odd period in addition to x=d²+D², we build y=c²+C², z=dc+DC and then L=−(2zu−y²), J=−(xu−yz/2) and J=xu−yz/2. It can be proved that the second term in J will be here half-integer only x=d²+D² even. Hence, we should use the equations for the even period in such situation where either y or z will be necessarily even. Since both d and D were odd the period is even: C=E₇(21,1,10,20,1,10,21)=1174195, c=E₆(21,1,10,20,1,10)=55672, b=E₅(21,1,10,20,1)=5083, B=E₆(10,21,1,10,20,1)=51062. Thus, we obtain J=1576344241068, L=313836425528, A=J²+L=2484861166348562734206152, and A is our message.

The recipient takes square root of A and transforms the fractional part of √A=1576344241068.0995456504206722579 . . . into the periodic chain fraction=[1576344241068;10,21,1,10,20,1,10,21,10,1,20,10,1,21,10,3152688482136]. The first half of the period is our message: “IT IS IT”!

As is clear from the example, this method requires significant computational resources for taking approximate square roots from a very large numbers with the high accuracy of several dozen of digits to obtain an exact periodic chain fraction. However, the recipient can deal with integers only using the algorithm proposed by the author (JCMSE, “On two Fermat's discoveries”, v. 16, p. 703, 2016): J₀=J, L₀=L(J+Jₚ)/Lₚ=kₚ₊₁|rₚ, Jₚ₊₁=J−rₚ, Lₚ₊₁=Lₚ₋₁+kₚ₊₁(Jₚ−Jₚ₊₁), p=0, 1 (11) The insertion from the left demonstrates how the algorithm (11) acts in the case of “IT IS IT”.

| | | | | Lₚ₊₁₌ = |
|---|---|---|---|---|
| p | kₚ₊₁\|rₚ = (J + Jₚ)/Lₚ | | Jₚ₊₁ = J − rₚ | Lₚ₋₁ + kₚ₊₁(Jₚ − Jₚ₊₁) |
| 0 | 10 | 14324226856 | 1562020014212 | 143242268561 |
| 1 | 21 | 130276615499 | 1446067625569 | 2748836587031 |
| 2 | 1 | 273575279606 | 1302768961462 | 286540932668 |
| 3 | 10 | 13703875850 | 1562640365218 | 150122549471 |
| 4 | 20 | 136533616866 | 1439810624202 | 2743135752988 |
| 5 | 1 | 273019112282 | 1303325128786 | 286608044887 |
| 6 | 10 | 13588920984 | 1562755320084 | 148833840008 |
| 7 | 21 | 13588920984 | 1562755320084 | 286608044887 |

1. the process of information transfer between two terminals, each equipped by a commercial computer supplied by the program described in claims 2, 3, and connected to the internet;
the program encrypts each block of a plain text combining it with a random element (number, set of letters, etc. not preliminary delivered to the recipient) and, thus, guarantees an absolute security of the communication line, satisfying the Shannon criterion of unbreakable code;
the program starts from a sequence of mathematical manipulations, which transform a block of plain text and a random number into a unique natural number, which, therefore, itself becomes random; the way of combination of plain text with a random element (positions, etc.) serves as a key;
the program at the recipient's terminal restores the entire block of the plain text from the obtained number and simultaneously remove the random elements by means of reciprocal mathematical procedures;
this principle of coding satisfies the Shannon criterion of an unbreakable code, but does not require a preliminary delivery of random elements.

2. the description of four versions of numerical procedures from claim 1 named the “dictionary” method, the “anagram” method, the Euclidian (“division”), and the “square root-chain fraction” methods;
the block of plain text with k₁, k₂, . . . , kₙ letter numbers in alphabet and the block length n is endowed by a number
$${N}_{{k}_{1} {k}_{2} … {k}_{n}} = ( \begin{matrix}mn \\ n\end{matrix} ) - {\sum }_{j = 1}^{n} ( \begin{matrix}mn - {s}_{j} \\ n - j + 1\end{matrix} ) ,$$
s₁=k₁, sⱼ=kⱼ+sⱼ₋₁, j=2, 3, . . . , n, from which the letter numbers are restored by means of equations
$${N}_{1} = ( \begin{matrix}mn \\ n\end{matrix} ) - {N}_{{k}_{1} {k}_{2} … {k}_{n}} ,$$
s₁=mn−L(n, N₁), k₁=s₁, Nⱼ₊₁=
$${N}_{j} = ( \begin{matrix}mn - {s}_{j} \\ n - j + 1\end{matrix} ) ,$$
sⱼ₊₁=mn−L(n−j, Nⱼ₊₁), kⱼ₊₁=sⱼ₊₁−sⱼ, j=1, 2, . . . , n in the dictionary method; the integer hash function L(n, N) is defined by the inequality:
$$if ( \begin{matrix}L \\ n\end{matrix} ) < N < ( \begin{matrix}L + 1 \\ n\end{matrix} )$$
with the initial value [(n!N)^{1/n}+n/2] for L; ([ ] denote the integer part and
$$( \begin{matrix}L \\ n\end{matrix} )$$
is the binomial coefficient);
the anagram k₁ⁿ^{₁}k₂ⁿ^{₂} . . . kₗⁿ^{ₗ}, k₁<k₂< . . . <kₗ, nⱼ are numbers of repetitions of each different anagram letter, is endowed by the number
$$G = ( \begin{matrix}n + {k}_{l} - 1 \\ n\end{matrix} ) + {\sum }_{j = 1}^{l - 1} [ ( \begin{matrix}{s}_{j} + {k}_{j} - 1 \\ {s}_{j}\end{matrix} ) - ( \begin{matrix}{s}_{j} + {k}_{j + 1} - 1 \\ {s}_{j}\end{matrix} ) ] ,$$
sⱼ=Σₚ₋₁^{j}nₚ, sₗ=n, and by additional number
$$K = ( \frac{( {n}^{2} + 3 n - 2 ) / 2}{n - 1} ) - {\sum }_{j = 1}^{n - 1} ( \frac{{s}_{n - j} + n - j - 1}{n - j} ) ,$$
sⱼ=Σᵢ₋₁^{j}pⱼ, which allows to restore the order of letters in the block; here pⱼ are numbers of positions of block letters (ordered alphabetically) in order of their appearance in the block: first—of the first appearance of each letter, next—of the second appearance and so on;
the letter numbers k₁, k₂, . . . , kₗ are restored similarly to the anagram method, but in back order, mentioned by the upper position of the index k^{(l-j+1)}=kⱼ, s^{(l-j+1)}=sⱼ, beginning from N⁽¹⁾=G, s⁽¹⁾=n:
k^{(j)}=L(s^{(j)}, N^{(j)})−s^{(j)}+2,
$${M}^{( j )} = ( \begin{matrix}{k}^{( j )} + {s}^{( j )} - 1 \\ {s}^{( j )}\end{matrix} ) - {N}^{( j )} ,$$
s^{(j+1)}=L(k^{(j)}−1, M^{(j)})−k^{(j)}+2,
$${N}^{( j + 1 )} = ( \begin{matrix}{k}^{( j )} + {s}^{( j + 1 )} - 1 \\ {k}^{( j )} - 1\end{matrix} ) - {M}^{( j )} ,$$
j=1, 2 . . . , l−1;
in the peculiar situation: L(s^{(j)}, N^{(j)})=N^{(j)} (not <), a modified equation k^{(j)}=L(s^{(j)}, N^{(j)})−s^{(j)}+1 should be used; the appearance of N^{(l-1)}=0 finalizes the calculations and determines the number of different letters l in the anagram, which the recipient did not initially know;
each of above algorithms does not immediately recognize a false 15-letter block number only in one out of quarter of-a-million cases;
the simple division and square root methods also allow to hide random numbers (letters); the first one starts from building two numbers d and D beginning from E₁(k₁)=k₁, E₂(k₁, k₂)=k₁k₂+1 then by means of Eₙ=kₙEₙ₋₁+Eₙ₋₂; d=Eₙ₋₁(k₁, . . . , kₙ₋₁), D=Eₙ(k₁, . . . , kₙ); the recipient having received d and D uses Euclidian algorithm to find their GCD and obtains k₁, . . . , kₙ as intermediate quotients;
the square root method requires using c=Eₙ₋₂(k₂, . . . , kₙ₋₁), C=Eₙ₋₁(k₂, . . . kₙ), B=Eₙ₋₂(k₁, . . . kₙ₋₂), b=Eₙ₋₃(k₂, . . . , kₙ₋₂) in addition to d and D; first find x=d²+D²; if x is even calculate y=c²+C², z=dc+DC, u=1+[y²/2z], L=−(2zu−y²), and J=xu−yz/2; if x is odd recalculate x=d(D+B) and then y=c(C+b), z²=xy+1, u=1+[y²/2z], L=2zu−y², and J=xu−yz/2; the message is A=J²+L; the recipient takes square root of A and transforms the fractional part of √A into the periodic chain fraction; the first half of the period will be the block text k₁, . . . , kₙ.

3. The acting sample secure communication line between two terminals each supplied by a commercial computer, connected to the internet and including the programmed above procedures (available on a compact disk) of unbreakable coding and decoding based on the dictionary, anagram and division algorithms from claim 2.
